(19) United States
(12) Patent Application Publication
(10) Pub. No.: US 2019/0313651 A1
(43) Pub. Date: Oct. 17, 2019

(54) Method for the Open-Loop and/or Closed-Loop Control of the Gas Thoroughput in the Baking Chamber of a Baking Device

(71) Applicant: HAAS FOOD EQUIPMENT GMBH, Leobendorf (AT)

(72) Inventors: Markus Bibaric, Kierling (AT); Stefan Jiraschek, Königsbrunn (AT); Karl Miller, Wien (AT)

(73) Assignee: HAAS FOOD EQUIPMENT GMBH, Leobendorf (AT)

(21) Appl. No.: 16/468,989

(22) PCT Filed: Dec. 13, 2017
(86) PCT No.: PCT/EP2017/082624

§ 371 Date: Jun. 12, 2019

(30) Foreign Application Priority Data
Dec. 15, 2016 (EP) 16204210.5

(51) Int. Cl. A21B 1/48; A21B 1/26; A21B 1/28; A21B 1/40

(52) U.S. Cl. CPC A21B 1/48; A21B 1/40; A21B 1/28; A21B 1/26

(57) ABSTRACT

Method for controlling gas flow rate in a baking device chamber having a chain of baking tongs moving along a path therethrough, including controlled introduction of a fuel volume flow, optional controlled introduction of a convection air volume flow, and controlled removal of a suction volume flow. A volume balance of the volume flow introduced into, the expanding volume flow expanding inside, and the volume flow removed by suction from the baking chamber is determined for controlling the suction volume flow and/or the convection air volume flow. The power(s) of a suction fan and/or convection fan is/are controlled in such a manner that the volume flow removed by suction is greater than or equal to the sum of the introduced volume flow and the expanding volume flow expanding inside the baking chamber so that the introduced volume flow and the expanding volume flow expanding inside the baking chamber are removed via the suction fan.

### CROSS-REFERENCE TO RELATED APPLICATION(S)

This application is the National Stage of International Patent Application No. PCT/EP2017/082624 filed on Dec. 13, 2017, which claims priority from European Patent Application No. 16204210.5 filed on Dec. 15, 2016, both of which are herein incorporated by reference herein in their entireties.

### BACKGROUND

### 1. Field of the Invention

The invention relates to a method for controlling and/or closed-loop controlling the gas flow rate in the baking chamber of a baking device in which an endless chain of baking tongs is moved along a closed path through a pre-head opening from a baking chamber into a pre-head and through a pre-head opening to the pre-head into the baking chamber during the production of baked, preferably edible products.

### 2. State of the Art

Baking devices for the industrial production of baked, preferably edible, products are known and published in different embodiments.

For example, baking devices are known in which baking tongs that can be opened and closed are provided along an endless conveyor, wherein the baking tongs are arranged in series and one after the other pass through a baking mass application area for applying a baking mass to opened baking tongs, a closing area for closing the baking tongs, a baking chamber heated by means of a heating device for baking the baked products in the closed baking tongs, an opening area for opening the baking tongs and a baked product removal area for removing the baked products from the opened baking tongs.

The following invention relates in particular to a baking device which is suitable for producing and/or configured to produce wafer products such as flat wafers or hollow wafers.

Also in the production of baked products, increased attention is paid to quality and production efficiency. In terms of production efficiency, particularly energy efficiency is of great importance.

Conventional baking ovens for the industrial production of wafer products have an elongated housing with an open underside and a vent at the top so that the entire baking chamber is vented from bottom to top. This arrangement allows high volumes of ambient air to pass into the baking chamber, which decreases the baking room temperature. According to the prior art, the heating power is increased to be able to counterbalance this heat loss.

In order to improve these baking ovens, baking devices of the same generic category with a substantially closed baking chamber are known, wherein a convection fan is optionally provided for generating forced convection and for flushing the baking chamber.

Baking devices of this kind—see e. g. EP 3 103 345 A1—usually comprise a pre-head in which the baking mass application takes place. This pre-head is usually not heated and is preferably flushed with fresh air so that the temperature in the pre-head is lower than in the baking chamber and in particular substantially corresponds to the ambient temperature. The baking tongs moved on the endless conveyor are moved from the baking chamber into the pre-head; hence, an opening from the baking chamber to the pre-head must be provided. According to the prior art, suction fans in the vent of the baking chamber have been used so far to prevent hot baking chamber gas from entering the pre-head. Without taking into account the actual suction power required, the fans' suction power was set so high that the suction fan also sucked part of the flow from the pre-head and air from the factory building through the pre-head opening. However, given this excessive suction power, more heat than necessary is withdrawn, which means that heat energy is lost.

In order to guarantee that no hot baking chamber gas can enter the pre-head of the baking oven, an insufficiently high suction power has not been an option so far.

In addition, maintenance works on the device also decrease the efficiency of the operation of conventional baking devices. Hence, in particular a formation of condensate, for example during the warm-up phase of the heating device, causes internal parts to corrode. For these parts to be replaced, production has to be stopped, resulting in a significant reduction in the efficiency of the baking device, in particular in the energy efficiency.

From U.S. Pat. No. 5,512,312, a wall radiation oven and a method for preparing a nutritional product are known, wherein an oxygen-poor oven atmosphere is to be produced in order to prevent the inflammation of fats.

### SUMMARY

Therefore, the object of the invention is to overcome the disadvantages of the prior art and, in particular, to provide a baking device with increased efficiency. This entails in particular the optimization of the gas flow rate in the baking chamber of the baking device. A further aim of the invention is to avoid that baking chamber gases enter the pre-head. It may further entail the provision of special warm-up and drying modes to prevent a corrosion of parts of the baking device.

The object according to the invention is in particular solved by the hereinafter described features.

The invention may relate to a method for controlling and/or closed-loop controlling the gas flow rate in the baking chamber of a baking device in which an endless chain of baking tongs is moved along a closed path through a pre-head opening from a baking chamber into a pre-head and through a pre-head opening from the pre-head into the baking chamber during the production of baked, preferably edible products, the method comprising the following steps:
controlled or closed-loop controlled introduction of a fuel volume flow of a fuel, in particular gaseous fuel, and a primary air volume flow into the baking device, wherein the fuel is combusted in a heating arrangement with the primary air of the primary air volume flow for heating the baking chamber,
optional controlled or closed-loop controlled supply of a convection air volume flow via a convection fan, wherein the convection air volume flow flows for creating a forced convection flow inside the baking chamber, the convection air volume flow optionally flowing through the baking chamber as secondary air,
and controlled or closed-loop controlled removal by suction of a suction volume flow from the baking chamber by means of a suction fan.

### BRIEF DESCRIPTION OF THE DRAWING

Subsequently, the invention is described further by means of an exemplary, but non-exclusive, embodiment.

FIG. 1 shows a schematic side view of a possible design of a baking oven according to the invention.

### DETAILED DESCRIPTION

Unless otherwise indicated, the numerals correspond to the following components: Baking chamber 1, baking device 2, chain of baking tongs 3, pre-head opening 4, pre-head 5, fuel volume flow 6, primary air volume flow 7, heating arrangement 8, convection air volume flow 9, suction volume flow 10, expanding volume flow 11, pre-head volume flow 12, volume flow of combustion components 13, baking steam volume flow 14, pair of baking tongs 15, endless conveyor 16.

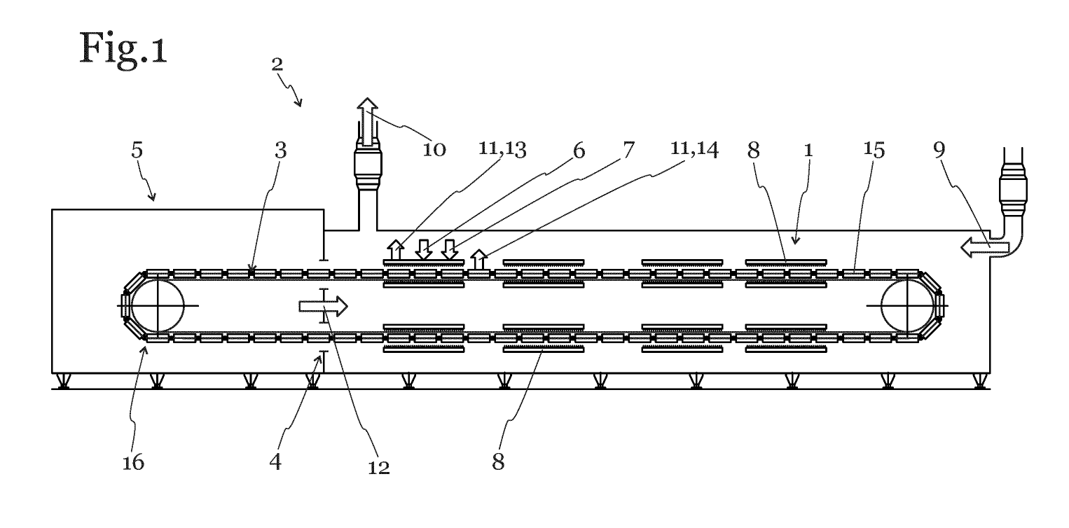

FIG. 1 shows a schematic side view of a baking device 2 in which the method for controlling and/or closed-loop controlling the gas flow rate according to the invention can be applied. The baking device 2 comprises an endless conveyor 16/a chain of baking tongs 3 on which baking tongs 15 are provided which are arranged in series. The baking device 2 has a pre-head 5 and a baking chamber 1. Inside the baking chamber 1 heating arrangements 8 are arranged. A fuel volume flow 6, in particular a gaseous fuel, and a primary air volume flow 7 are introduced into the heating arrangement 8. The fuel of the fuel volume flow 6 and the primary air of the primary air volume flow 7 are combusted in the heating arrangements 8 of the baking chamber 1 for heating the baking chamber 1. By combusting the fuel and the primary air, a volume flow of combustion components 13 is generated.

The volume flow of combustion components 13 in particular comprises the carbon dioxide volume flow and the water volume flow which is generated during the combustion of the fuel with the primary air. The volume flow of combustion components 13 further comprises a nitrogen volume flow of the primary air used for the combustion and, optionally, the excess air volume flow which results from a combustion of the fuel with excess air. Via a convection device, in particular a convection fan, a convection air volume flow 9 enters the baking chamber 1/baking device 2. In an operating mode with dough application, a baking steam volume flow 14 has to be taken into account in addition to the flow generated during the combustion of the fuel and the primary air, and the convection air volume flow 9. This baking steam volume flow 14 is generated by the intense heating of the baking mass. The water contained in the water-containing baking mass instantaneously evaporates and leaves the baking mass as it enters the baking chamber 1. The baking steam volume flow 14 depends in particular on the amount of water of the baking mass leaving the baking mass during baking and on the density of the leaving baking steam volume flow 14. In order to closed-loop control and/or control the suction volume flow 10 in a targeted manner, in the method according to the invention, which is also applied in this embodiment, a volume balance is determined for the baking device 2 and/or the baking chamber 1. To this end, the introduced volume flow consisting of the convection air volume flow 9 and the pre-head volume flow 12, the expanding volume flow 11 expanding inside the baking chamber 1 consisting of the volume flow of combustion components 13 and the baking steam volume flow 14 as well as the volume flow removed by suction from the baking chamber 1, i. e. the suction volume flow 10, are taken into account. In this embodiment, the power of the suction fan is closed-loop controlled in such a manner that the suction volume flow 10 is greater than the sum of the introduced volume flow and the expanding volume flow 11 expanding inside the baking chamber 1. This ensures that the introduced volume flow and the expanding volume flow 11 expanding inside the baking chamber 1 are removed by suction via the suction fan. It is thus prevented that baking chamber gases enter the pre-head 5.

In this embodiment, the baking device 2 comprises an endless chain of baking tongs 3 which moves in a continuously circulating manner along a self-contained path and through a baking chamber 1. The chain of baking tongs 3 comprises baking tongs 15 that can be opened and closed and that can in particular be folded open and closed. Along the path, one after the other, the baking tongs 15 pass through: a baking mass application area for applying a baking mass to an opened pair of baking tongs 15, a closing area for closing the baking tongs 15, the baking chamber 1 for baking the baking products inside the baking tongs 15, an opening area for opening the baking tongs 15 and a baked product removal area for removing the baked products from the opened baking tongs 15. The path along which the chain of baking tongs 3 moves in a circulating manner comprises in the following sequence: an upper substantially horizontal transport plane, a rear deflection area, a lower substantially horizontal transport plane and a front deflection area. A deflection by 180° in the rear deflection area leads the chain of baking tongs 3 from the upper transport plane to the lower transport plane. Further, a deflection by 180° in the front deflection area leads the chain of baking tongs 3 from the lower transport plane back to the upper transport plane.

It may be provided that a volume balance is determined of the volume flow introduced into the baking chamber, the volume flow expanding inside the baking chamber and the volume flow removed by suction from the baking chamber for controlling and/or closed-loop controlling the suction volume flow and/or the convection air volume flow and that the power of the suction fan and/or the power of the convection fan are controlled and/or closed-loop controlled in such a manner that the volume flow removed by suction is greater than or equal to the sum of the introduced volume flow and the volume flow expanding inside the baking chamber so that the introduced volume flow and the volume flow expanding inside the baking chamber are removed by suction—in particular completely—via the suction fan.

It may also be provided that the volume flow expanding inside the baking chamber of the volume balance comprises the volume flow of combustion components generated by the combustion of the fuel volume flow with the primary air volume flow and a baking steam volume flow leaving the baking mass during a baking thereof or that the volume flow expanding inside the baking chamber of the volume balance consists of the volume flow of combustion components generated by the combustion of the fuel volume flow with the primary air volume flow and a baking steam volume flow leaving the baking mass during a baking thereof.

It may be provided that the volume flow introduced into the baking chamber of the volume balance comprises the convection air volume flow and, optionally, a pre-head volume flow sucked in through the pre-head opening or that the volume flow introduced into the baking chamber of the volume balance consists of the convection air volume flow and the pre-head volume flow optionally sucked in through the pre-head opening.

It may be provided that the volume flow removed by suction from the baking chamber of the volume balance corresponds to the suction volume flow.

It may be provided that in the determination of the volume balance of the volume flow introduced into the baking chamber, the volume flow expanding inside the baking chamber and the volume flow removed by suction from the baking chamber the difference between the temperature of the introduced volume flow on entering the baking device or the baking chamber and the temperature of the introduced volume flow on leaving the baking device or the baking chamber is taken into account, wherein the expansion of volume due to the heating of the introduced volume flow is taken into account.

It may be provided that the baking steam volume flow leaving the baking mass during the baking thereof is formed according to the following formula:

$${\dot{V}}_{baking steam} = \frac{{\dot{m}}_{dought water}}{{ρ}_{dought steam}}$$

wherein \dot{V}_{baking steam} is the leaving baking steam volume flow, wherein \dot{m}_{dough water} is the baking mass water mass flow leaving the baking mass during baking thereof and wherein ρ_{dough steam} is the density of the leaving baking steam volume flow.

It may be provided that the volume flow removed by suction is greater than the sum of the introduced volume flow and the volume flow expanding inside the baking chamber by a safety factor in the range between 1.00 and 1.50, preferably between 1.05 and 1.25, more preferably 5%, which prevents baking chamber gases to enter the pre-head.

It may be provided that the power of the suction fan is set by controlling or closed-loop controlling the frequency of the main vent fan of the baking device.

It may be provided that the volume balance is determined according to the following formula:

$${\dot{V}}_{suction} = ( ( {\dot{V}}_{CO 2} + {\dot{V}}_{{H}_{2} O} + {\dot{V}}_{{N}_{2}} + {\dot{V}}_{excess air , {T}_{out}} ) + ( {\dot{V}}_{convection air , {T}_{in}} \cdot \frac{{T}_{out}}{{T}_{in}} ) + {\dot{V}}_{baking steam} + {\dot{V}}_{pre \text{-} head , {T}_{out}} ) \cdot S$$

wherein \dot{V}_{suction} is the suction volume flow,
wherein \dot{V}_{CO2}, \dot{V}_{H}_{₂}_{O}, \dot{V}_{N}_{₂} and \dot{V}_{excess air,T}_{ₒᵤₜ} make up the volume flow of combustion components,
wherein \dot{V}_{CO2} is the carbon dioxide volume flow generated during the combustion of the fuel with the primary air and, optionally, secondary air,
wherein \dot{V}_{H}_{₂}_{O} is the water volume flow generated during the combustion of the fuel with the primary air and, optionally, secondary air,
wherein \dot{V}_{N}_{₂} is the nitrogen volume flow of the primary air and, optionally, secondary air used for the combustion,
wherein \dot{V}_{excess air,T}_{ₒᵤₜ} is the excess air volume flow generated during a combustion of the fuel with excess air, the temperature of the excess air volume flow corresponding to the temperature on leaving the baking device or the baking chamber,
wherein \dot{V}_{convection air,T}_{ᵢₙ} is the convection air volume flow the temperature of which corresponds to the temperature on entering the baking device or the baking chamber,
wherein Tₒᵤₜ is the temperature of the convection air volume flow on leaving the baking device or the baking chamber,
wherein Tᵢₙ is the temperature of the convection air volume flow on entering the baking device or the baking chamber,
wherein \dot{V}_{baking steam} is the baking steam volume flow leaving the baking mass during the baking thereof,
wherein \dot{V}_{pre-head,T}_{ₒᵤₜ} is the pre-head volume flow the temperature of which corresponds to the temperature on leaving the baking device or the baking chamber,
and wherein S is the safety factor.

It may be provided that the method is preceded by a pre-heating phase and a drying phase and that the method comprises a first normal operating mode and a second normal operating mode and that the pre-heating phase precedes the drying phase and that the drying phase precedes the first normal operating mode and that the first normal operating mode precedes the second normal operating mode.

It may be provided that the method is preceded by a pre-heating phase, wherein the heating arrangement arranged inside the baking device is operated at a power of between 25% and 75%, preferably between 35% and 65%, more preferably 50% of its maximum power and wherein the suction fan and the convection fan are operated at a power of between 50% and 100%, preferably between 75% and 100%, more preferably 100% of their maximal power.

It may be provided that the method is preceded by a drying phase, wherein the heating arrangement arranged inside the baking device is operated at a power of between 50% and 85%, preferably between 60% and 75%, more preferably 66% of its maximum power and wherein the suction fan and the convection fan are operated at a power of between 50% and 100%, preferably between 75% and 100%, more preferably 100% of their maximal power.

It may be provided that the method comprises a first normal operating mode, wherein in this first normal operating mode the heating arrangement arranged inside the baking device is operated at a power of between 50% and 100%, preferably between 75% and 100%, more preferably 100% of its maximum power.

It may be provided that the method comprises a second normal operating mode, wherein in this second normal operating mode the power of the heating arrangement arranged inside the baking device is closed-loop controlled or controlled by setting a target temperature, in particular a baking plate target temperature, wherein the baking plate target temperature is or can be determined by means of a temperature measuring device, in particular a temperature sensor, arranged on the outside of a baking plate of the chain of baking tongs.

It may be provided that that convection air volume flow comprises a frame cooling air volume flow, wherein the frame cooling air volume flow is adapted to cool parts of the baking device.

It may be provided that the endless chain of baking tongs moves in a continuously circulating manner along a self-contained path through the baking chamber and that the chain of baking tongs comprises baking tongs that can be opened and closed and that can in particular be folded open and folded closed, and that the baking chamber is preferably configured as substantially closed baking chamber.

In all embodiments, it may be provided that the baking chamber is a substantially closed baking chamber. This means in particular that the baking chamber is only provided with the openings necessary for introducing and removing the baking tongs and the said volume flows. The essentially closed configuration of the baking chamber causes or promotes a horizontal convection flow of the gases in the baking chamber or a convection flow of the gases in the baking chamber that follows the main extension direction of the chain of baking tongs.

In all embodiments, the volume flow expanding inside the baking chamber can be an expanding introduced volume flow. The volume flow expanding inside the baking chamber can consist of components that have been introduced into the baking chamber and that expand inside the baking chamber or it can comprise the same. Thus, the mass flow of the individual component flows stays substantially constant. Only the volume flow of these component flows may increase. The volume flow expanding inside the baking chamber may comprise the baking steam volume flow which is generated by the phase transition of the dough water or baking mass water contained in the baking mass or it may consist of it. The volume flow expanding inside the baking chamber may comprise the volume flow of combustion components which is generated by the combustion of the fuel volume flow and the primary air volume flow or it may consist of it.

In the method according to the invention a volume balance is determined which takes into account all the relevant volume flows of the baking device so that the gas flow rate in the baking chamber can be optimized. To this end, sensors, control devices for fans and/or stored maps are optionally provided. In the volume balance, the volume flow introduced into the baking chamber, the volume flow expanding inside the baking chamber and the volume flow removed by suction from the baking chamber are preferably taken into account. Then one or more fan/s is/are controlled in such a manner that it is guaranteed that the volume flow removed by suction is greater than or equal to the introduced volume flow and the volume flow expanding inside the baking chamber. The volume flow removed by suction is described as greater than or equal to because a safety factor may be used in order to take into account computational inaccuracies, for example. In contrast to conventional baking devices, however, this safety factor may be kept small depending on the components of the baking device. This safety factor can further be kept small depending in particular on the volume flow and in particular also on the load; hence, the gas flow rate in the baking chamber is optimized.

The volume flow introduced into the baking chamber of the volume balance comprises in particular a convection air volume flow introduced into the baking chamber by means of a convection fan.

The volume flow introduced into the baking chamber of the volume balance may comprise a pre-head volume flow sucked in through the pre-head opening, wherein the pre-head volume flow may be kept as small as possible. The volume flow introduced into the baking chamber of the volume balance may comprise a frame cooling air volume flow configured to cool parts of the baking device.

The volume flow expanding inside the baking chamber of the volume balance comprises, for example, the volume flow of combustion components generated during the combustion of the fuel with the primary air. It comprises for example the combustion gases which are generated when the fuel is combusted with air by means of the burners inside the baking chamber and/or which are introduced into the baking chamber via the burners; optionally, it also comprises air components when the fuel is combusted with excess air. The volume flow of combustion components thus comprises in particular a carbon dioxide volume flow, a water volume flow, a nitrogen volume flow and—in case of a combustion with excess air—in particular a generated air excess volume flow.

In addition, a baking steam volume flow may be generated inside the baking chamber, which leaves the baking mass in the form of steam due to the intense heating of the baking mass, in particular the water-containing baking mass. Baking masses for the production of baked products usually contain water, wherein this water evaporates instantaneously when the baking tongs enter the baking chamber and leaves the baking mass introduced into the baking device/the baking tongs transporting/conveying the baking mass.

The volume balance further takes into account the compression or expansion of the different volume flows and/or gases due to the heating or cooling of the volume flows and/or the gases inside the baking chamber. By taking into account a temperature correction of the volume flows and/or the gases, in particular of the convection air volume flow, the suction volume flow/the power of the suction fan can be adjusted and the efficiency of the baking device can thus be increased.

Preferably, the convection air volume flow and/or the suction volume flow is/are controlled and/or closed-loop controlled for controlling and/or closed-loop controlling the gas flow rate. This control and/or closed-loop control is, for example, possible by adapting the power of the convection fan or the suction fan.

In order to determine the volume balance, it may be necessary to know further parameters of the method. For determining the convection air volume flow a sensor may optionally be provided, which is configured to measure and/or monitor the volume flow. Optionally, such a sensor may also be provided for monitoring and/or measuring the suction volume flow. Optionally, such a sensor may also be provided for measuring and/or monitoring the primary air volume flow and/or the fuel volume flow. Optionally, a sensor may be provided, which is configured to monitor and/or measure the introduced baking mass volume flow. Optionally, a sensor may be provided, which is configured to monitor and/or measure the introduced pre-head volume flow. Then, the baking mass water mass flow can be calculated from the baking mass volume flow. Optionally, a control device for the convection fan and/or the suction fan may be provided.

Optionally, a control device and/or a closed-loop control device may be provided which is/are configured to evaluate all of the signals measured and/or monitored by the sensors and/or control devices. Optionally, this control device and/or closed-loop control device may be configured to execute the method for controlling and/or closed-loop controlling the gas flow rate in the baking chamber.

Alternatively or additionally, a volume flow introduced via a fan can be determined by means of characteristic numbers/maps of the fan. From the rotational speed of the fan, for example, the delivery rate and, hence, the delivered volume flow can be determined.

The expansion of the gases due to the heating in the baking chamber can, for example, be calculated using the ratio of the temperatures of the supplied volume flow and/or the supplied volume flows and/or the gases to the temperature in the baking chamber. The baking steam volume flow results in particular from the water content of the baking mass, the amount of baking mass applied per pair of baking tongs, the supply rate of the endless conveyor/the baking tongs and optionally from the density of the emergent baking steam.

Optionally, no dough application takes place during the operation of the baking device. In this case, the control and/or closed-loop control device detects—in particular by means of the baking mass application device—that the baking mass volume flow is zero; hence, also the baking steam volume flow of the recently supplied baking tongs is zero. In this case, the baking steam volume flow drops out of the balance due to the calculation.

The volume flows of the combustion gases are in particular obtained from conventional combustion equations of the used fuel and the primary air. Optionally, an excess air volume flow, which is generated during the combustion of the fuel with excess air, has to be taken into account and removed by suction. Optionally, the volume flow of combustion components can be calculated from the heating power and the lambda value.

For example, an oxygen sensor/lambda probe may be provided in order to be able to determine the excess air volume flow.

The pre-head volume flow can, for example, be chosen from experience and can in particular be in the range of 200 to 2000 m³/h, preferably between 400 and 1200 m³/h. More preferably, the pre-head volume flow is less than 800 m³/h.

An advantage of the method according to the invention for controlling and/or closed-loop controlling the gas flow rate in the baking chamber by determining a volume balance is the closed-loop control speed and/or control speed/the possibility of an anticipatory closed-loop control and/or control.

The volume to be removed by suction/the volume flow to be removed by suction increases instantaneously when a change is made from an operational mode without baking mass application to an operational mode with baking mass application since a large baking steam volume instantaneously leaves the baking mass introduced into the baking device/the baking tongs transporting the baking mass when baking mass is applied. Since the application of the baking mass and the leaving of the steam in the baking chamber take place with a certain delay, the power of the suction fan can be increased already in advance, in order to be able to respond to the volume flow expanding inside the baking chamber.

Hence, the method according to the invention allows the power of the convection fan and/or the suction fan to be adjusted in advance. This increases the efficiency of the baking device and prevents in particular baking room gases from entering the pre-head.

Another advantage of the method according to the invention is that the exactly adjusted convection air flow and/or the suction volume flow reduce/s or decrease/s unnecessary volume flows, in particular the spurious air volume flow, to a minimum. Hence, preferably only those volume flows that are absolutely necessary are introduced into the baking chamber, which greatly increases the efficiency, in particular the energy efficiency, of the baking device. On the one hand, the required power of the convection fan and/or the suction fan is reduced. On the other hand, the method according to the invention allows the temperature of the leaving suction volume flow to be substantially higher than in conventional baking devices, which allows any downstream heat exchangers to be operated much more efficiently. The increased temperature of the suction volume flow also allows the efficiency of any downstream heat exchanger to be significantly increased. This allows the efficiency, in particular the energy efficiency, of the baking device and the entire production, to be significantly increased or improved.

The decreased dilution of the suction volume flow allows the exit temperature of the suction volume flow to be substantially higher.

Another advantage of the control and/or closed-loop control according to the invention is that the dimensions of the systems for venting and/or air-conditioning the building surrounding the baking device can be considerably smaller in their power.

Hence, increasing the efficiency of the baking device allows the efficiency of the entire production to be increased.

It may be provided that the endless chain of baking tongs moves in a continuously circulating manner along a self-contained path through the baking chamber and that the chain of baking tongs comprises baking tongs that can be opened and closed and that can in particular be folded open and folded closed.

It may further be provided that along the path, one after the other, the baking tongs pass through: a baking mass application area for applying a baking mass to an opened baking tong, a closing area for closing the baking tongs, the baking chamber for baking the baked products inside the baking tongs, an opening area for opening the baking tongs and a baked product removal area for removing the baked products from the opened baking tongs.

It may be provided that the path along which the chain of baking tongs moves in a circulating manner comprises in the following sequence: an upper substantially horizontal transport plane, a rear deflection area, a lower substantially horizontal transport plane and a front deflection area, that a deflection by 180° in the rear deflection area leads the chain of baking tongs from the upper transport plane to the lower transport plane, and that a deflection by 180° in the front deflection area leads the chain of baking tongs from the lower transport plane back to the upper transport plane.

1-14. (canceled)

15. A method for controlling and/or closed-loop controlling the gas flow rate in the baking chamber (1) of a baking device (2) in which an endless chain of baking tongs (3) is moved along a closed path through a pre-head opening (4) from a baking chamber (1) into a pre-head (5) and through a pre-head opening (4) from the pre-head (5) into the baking chamber (1) for producing baked products, the method comprising:
controlled introduction of a fuel volume flow (6) and a primary air volume flow (7) into the baking device (2), wherein the fuel is combusted in a heating arrangement (8) with the primary air of the primary air volume flow (7) for heating the baking chamber (1);
optional controlled introduction of a convection air volume flow (9) via a convection fan, wherein the convection air volume flow (9) flows through the baking chamber (1) for creating a forced convection flow inside the baking chamber (1), the convection air volume flow optionally flowing through the baking chamber as secondary air; and
controlled removal by suction of a suction volume flow (10) from the baking chamber (1) by means of a suction fan, wherein
a volume balance of the volume flow introduced into the baking chamber (1), the expanding volume flow (11) expanding inside the baking chamber (1) and the volume flow removed by suction from the baking chamber (1) are determined for controlling the suction volume flow (10) and/or the convection air volume flow (9),
the expanding volume flow (11) expanding inside the baking chamber (1) of the volume balance comprises the volume flow of combustion components (13) generated by the combustion of the fuel volume flow (6) with the primary air volume flow (7) and a baking steam volume flow (14) leaving the baking mass during a baking thereof, and
the power of the suction fan and/or the power of the convection fan is/are controlled in such a manner that the volume flow removed by suction is greater than or equal to the sum of the introduced volume flow and the expanding volume flow (11) expanding inside the baking chamber (1) so that the introduced volume flow and the expanding volume flow (11) expanding inside the baking chamber (1) are removed by suction by means of the suction fan.

16. The method according to claim 15, wherein the controlled introduction of a fuel volume flow (6) and a primary air volume flow (7) is a closed-loop controlled introduction, the optional controlled introduction of a convection air volume flow (9) via a convection fan is a closed-loop controlled introduction, and the controlled removal by suction of a suction volume flow (10) is a closed-loop controlled removal.

17. The method according to claim 15, wherein the expanding volume flow (11) expanding inside the baking chamber (1) of the volume balance consists of the volume flow of combustion components (13) generated by the combustion of the fuel volume flow (6) with the primary air volume flow (7) and a baking steam volume flow (14) leaving the baking mass during a baking thereof.

18. The method according to claim 15, wherein the volume flow introduced into the baking chamber (1) of the volume balance comprises the convection air volume flow (9).

19. The method according to claim 15, wherein the volume flow introduced into the baking chamber (1) of the volume balance consists of the convection air volume flow (9) and a pre-head volume flow (12) sucked in through the pre-head openings (4),

20. The method according to claim 15, wherein the volume flow removed by suction from the baking chamber (1) of the volume balance corresponds to the suction volume flow (10).

21. The method according to claim 15, wherein in the determination of the volume balance of the volume flow introduced into the baking chamber (1), the expanding volume flow (11) expanding inside the baking chamber (1) and the volume flow removed by suction from the baking chamber (1) the difference between the temperature of the introduced volume flow on entering the baking device (2) or the baking chamber (1) and the temperature of the introduced volume flow on leaving the baking device (2) or the baking chamber (1) is taken into account, wherein the expansion of volume due to the heating of the introduced volume flow is taken into account.

22. The method according to claim 15, wherein the baking steam volume flow (14) leaving the baking mass during the baking thereof is determined according to:
$${\dot{V}}_{baking steam} = \frac{{\dot{m}}_{dough water}}{{ρ}_{dough steam}}$$
where \dot{V}_{baking steam} is the leaving baking steam volume flow (14), \dot{m}_{dough water} is the baking mass water mass flow leaving the baking mass during baking thereof, and ρ_{dough stream} is the density of the leaving baking steam volume flow (14).

23. The method according to claim 15, wherein the volume flow removed by suction is greater than the sum of the introduced volume flow and the expanding volume flow (11) expanding inside the baking chamber (1) by a safety factor in the range between 1.00 and 1.50.

24. The method according to claim 23, wherein said safety factor range is selected between 1.05 and 1.25 and prevents baking chamber gases from entering the pre-head (5).

25. The method according to claim 15, wherein the power of the suction fan is set by controlling a frequency of a main vent fan of the baking device (2).

26. The method according to claim 15, wherein the volume balance is determined according to the following formula:
$${\dot{V}}_{suction} = ( ( {\dot{V}}_{CO 2} + {\dot{V}}_{{H}_{2} O} + {\dot{V}}_{{N}_{2}} + {\dot{V}}_{excess air , {T}_{out}} ) + ( {\dot{V}}_{convection air , {T}_{in}} \cdot \frac{{T}_{out}}{{T}_{in}} ) + {\dot{V}}_{baking steam} + {\dot{V}}_{pre \text{-} head , {T}_{out}} ) \cdot S$$
wherein \dot{V}_{suction} is the suction volume flow (10),
wherein \dot{V}_{CO2}, \dot{V}_{H}_{₂}_{O}, \dot{V}_{N}_{₂} and \dot{V}_{excess air,T}_{ₒᵤₜ} make up the volume flow of combustion components (13),
wherein \dot{V}_{CO2} is the carbon dioxide volume flow generated during the combustion of the fuel with the primary air and, optionally, secondary air,
wherein \dot{V}_{H}_{₂}_{O} is the water volume flow generated during the combustion of the fuel with the primary air and, optionally, secondary air,
wherein \dot{V}_{N}_{₂} is the nitrogen volume flow of the primary air and, optionally, secondary air used for the combustion,
wherein \dot{V}_{excess air,T}_{ₒᵤₜ} is the excess air volume flow generated during a combustion of the fuel with excess air, the temperature of the excess air volume flow corresponding to the temperature on leaving the baking device (2) or the baking chamber (1),
wherein \dot{V}_{convection air,T}_{ᵢₙ} is the convection air volume flow (9) the temperature of which corresponds to the temperature on entering the baking device (2) or the baking chamber (1),
wherein Tₒᵤₜ is the temperature of the convection air volume flow (9) on leaving the baking device (2) or the baking chamber (1),
wherein Tᵢₙ is the temperature of the convection air volume flow (9) on entering the baking device (2) or the baking chamber (1),
wherein \dot{V}_{baking steam} is the baking steam volume flow (14) leaving the baking mass during the baking thereof,
wherein \dot{V}_{pre-head,T}_{ₒᵤₜ} is the pre-head volume flow (12) the temperature of which corresponds to the temperature on leaving the baking device (2) or the baking chamber (1), and
wherein S is the safety factor.

27. The method according to claim 15, further comprising a pre-heating phase and a drying phase, and wherein the method comprises a first normal operating mode and a second normal operating mode, with the pre-heating phase preceding the drying phase, the drying phase precedes the first normal operating mode, and the first normal operating mode precedes the second normal operating mode.

28. The method according to claim 15, further comprising a pre-heating phase during which the heating arrangement (8) arranged inside the baking device (2) is operated at a power of between 25% and 75% of its maximum power and wherein the suction fan and the convection fan are operated at a power of between 50% and 100% of their maximal power.

29. The method according to claim 28, wherein during the pre-heating phase the heating arrangement (8) arranged inside the baking device (2) is operated at a power of between 35% and 65% and more preferably 50% of its maximum power and the suction fan and convection fan are operated at a power of preferably between 75% and 100% and more preferably 100% their maximal powers.

30. The method according to claim 15, further comprising a drying phase wherein the heating arrangement (8) arranged inside the baking device (2) is operated at a power of between 50% and 85% of its maximum power and wherein the suction fan and the convection fan are operated at a power of between 50% and 100% of their maximal powers.

31. The method according to claim 30, wherein during the drying phase, the heating arrangement (8) arranged inside the baking device (2) is operated at a power of between 60% and 75% of its maximum power, and the suction fan and the convection fan are operated at a power of between 75% and 100% of their maximal powers.

32. The method according to claim 15, characterized in that the method comprises a first normal operating mode, wherein in this first normal operating mode, the heating arrangement (8) arranged inside the baking device (2) is operated at a power of between 75% and 100%, of its maximum power.

33. The method according to claim 32, further comprising a second normal operating mode, wherein in this second normal operating mode the power of the heating arrangement (8) arranged inside the baking device (2) is either closed-loop controlled or controlled by setting a target temperature, wherein the target temperature is determined by means of a measuring device.

34. The method according to claim 15, further comprising a second normal operating mode, wherein in this second normal operating mode the power of the heating arrangement (8) arranged inside the baking device (2) is either closed-loop controlled or controlled by setting a baking plate target temperature, wherein the baking plate target temperature is determined by means of a temperature sensor arranged on the outside of a baking plate of the chain of baking tongs (3).

35. The method according to claim 15, wherein the convection air volume flow (9) comprises a frame cooling air volume flow, wherein the frame cooling air volume flow is adapted to cool parts of the baking device (2).

36. The method according to claim 15, wherein the volume flow introduced into the baking chamber (1) of the volume balance comprises a pre-head volume flow (12) sucked in through the pre-head opening (4).

37. The method according to claim 15, wherein the power of the suction fan and/or the power of the convection fan is/are controlled in such a manner that the volume flow removed by suction is greater than or equal to the sum of the introduced volume flow and the expanding volume flow (11) expanding inside the baking chamber (1) so that the introduced volume flow and the expanding volume flow (11) expanding inside the baking chamber (1) are completely removed by suction by means of the suction fan.
